(19) United States
(12) Patent Application Publication
(10) Pub. No.: US 2011/0245432 A1
(43) Pub. Date: Oct. 6, 2011

(54) METHOD FOR PRODUCING THERMOPLASTIC RESIN COMPOSITION

(75) Inventors: Mitsuo MAEDA, Tsukuba-shi (JP); Satoshi OKAMOTO, Tsukuba-shi (JP); Yasuo MATSUMI, Tsukuba-shi (JP)

(73) Assignee: SUMITOMO CHEMICAL COMPANY, LIMITED, Tokyo (JP)

(21) Appl. No.: 13/072,103

(22) Filed: Mar. 25, 2011

(30) Foreign Application Priority Data
Mar. 30, 2010 (JP) 2010-077185

(51) Int. Cl. C08L 69/00; C08L 81/06; C08J 3/00

(52) U.S. Cl. 525/462

(57) ABSTRACT

The present invention provides a method for producing a thermoplastic resin composition, the method comprising a step of melt-kneading 5 to 55 parts by weight of an aromatic polycarbonate resin and 95 to 45 parts by weight of an aromatic polysulfone resin while shearing at a sharing speed of 1,000 to 9,000/sec. By the method, a thermoplastic resin composition excellent heat resistance and transparency can be obtained.

### BACKGROUND OF THE INVENTION

1. Field of the Invention

The present invention relates to a method for producing a thermoplastic resin composition containing an aromatic polycarbonate resin and an aromatic polysulfone resin.

2. Description of the Related Art

A thermoplastic resin composition containing an aromatic polycarbonate resin and an aromatic polysulfone resin has been studied as an excellent resin material which has both impact resistance and melt fluidity of the aromatic polycarbonate resin and chemical resistance of the aromatic polysulfone resin and, for example, JP-B-45-39181, JP-B-49-13855, JP-A-54-28361 and JP-A-60-51739 disclose thermoplastic resin compositions. However, the thermoplastic resin compositions disclosed in JP-B-45-39181, JP-B-49-13855, JP-A-54-28361 and JP-A-60-51739 have sometimes insufficient heat resistance since heat resistance of the aromatic polysulfone resin is obstructed by the aromatic polycarbonate resin. Therefore, it has been studied to improve the heat resistance of the thermoplastic resin composition. For example, JP-A-10-212403 discloses a thermoplastic resin containing an aromatic polycarbonate resin and an aromatic polysulfone resin in which a ratio of melt viscosity is within a predetermined range.

### SUMMARY OF THE INVENTION

The thermoplastic resin composition disclosed in JP-A-10-212403 is excellent in heat resistance. However, it is difficult for the thermoplastic resin composition to become transparent because of poor compatibility between the aromatic polycarbonate resin and the aromatic polysulfone resin, and also to use in applications that require transparency. Thus, an object of the present invention is to provide a method capable of producing a thermoplastic resin composition which contains an aromatic polycarbonate resin and an aromatic polysulfone resin, and has not only excellent heat resistance but also excellent transparency.

In order to achieve the above object, the present invention provides a method for producing a thermoplastic resin composition, the method comprising a step of melt-kneading 5 to 55 parts by weight of an aromatic polycarbonate resin and 95 to 45 parts by weight of an aromatic polysulfone resin while shearing at a shearing speed of from 1,000 to 9,000/sec.

### DETAILED DESCRIPTION OF PREFERRED EMBODIMENTS

In the present invention, a thermoplastic resin composition is produced by a method which comprises a step of melt-kneading an aromatic polycarbonate resin and an aromatic polysulfone resin under shearing conditions.

The aromatic polycarbonate resin used in the present invention may be a resin containing a repeating unit represented by the following formula (I) (hereinafter sometimes referred to as a “repeating unit (I)”):

-A-O—CO—O— (I)

wherein A represents a group derived from a dihydric phenol.

The content of the repeating unit (I) in the aromatic polycarbonate resin is usually 50 mol % or more, preferably 80 mol % or more, based on the total amount of the whole repeating unit, and it is more preferable that substantially the whole repeating unit is a repeating unit (I). The aromatic polycarbonate resin may contain two or more kinds as the repeating unit (I). Also, a mixture of two or more kinds may be used as the aromatic polycarbonate resin.

In the formula (I), a group derived from a dihydric phenol represented by A is a residue in which the respective hydrogen atoms of two hydroxyl groups have been removed from the dihydric phenol. Also, the dihydric phenol is a monocyclic or polycyclic aromatic compound having two hydroxyl groups bonded directly to a carbon atom of an aromatic ring. Examples of the dihydric phenol include 2,2-bis(4-hydroxyphenyl)propane (bisphenol A), bis (4-hydroxyphenyl)methane, 2,2-bis(4-hydroxy-3-methylphenyl)propane, 2,2-bis(3,5-dichloro-4-hydroxyphenyl)propane, 2,2-bis(3,5-dibromo-4-hydroxyphenyl)propane, 1,1-bis(4-hydroxyphenyl)cyclohexane, hydroquinone, resorcinol and dihydroxydiphenyl.

The aromatic polycarbonate resin preferably has a group derived from bisphenol A. The content of the group derived from bisphenol A in the aromatic polycarbonate resin is preferably 30 mol or more, more preferably 50 mol or more, still more preferably 80 mol % or more, based on the total amount of the group derived from the dihydric phenol, and it is particularly preferable that substantially the whole group derived from the dihydric phenol is a group derived from the bisphenol A. An end group of the aromatic polycarbonate can be appropriately selected according to the production method, and examples thereof include —OH and —OC(CH₃)₃.

Also, a melt viscosity measured at 340° C. and a shearing speed of 1,216/sec of the aromatic polycarbonate resin is preferably from 200 to 1,000 Pass, and more preferably from 200 to 600 Pa·s. It is not preferred that the melt viscosity is too high since the melt viscosity of the obtained composition also becomes higher and it becomes difficult to process the composition. Also, it is not preferred that the melt viscosity is too low since the heat resistance and mechanical strength of the obtained composition are likely to deteriorate.

The aromatic polysulfone resin is a polyarylene compound which contains an arylene unit, an ether bond (—O—) and a sulfone bond (—SO₂—) as essential components, the arylene unit being located at random or orderly by the ether bond and the sulfone bond.

The aromatic polysulfone resin preferably contains a repeating unit represented by the following formula (1) (hereinafter sometimes referred to as a “repeating unit is (1)”), and may further contain a repeating unit represented by the following formula (2) (hereinafter sometimes referred to as a “repeating unit (2)”) and/or a repeating unit represented by the following formula (3) (hereinafter sometimes referred to as a “repeating unit (3)”).

-Ph¹-SO₂-Ph²-O— (1)

wherein Ph¹ and Ph² each independently represents a group represented by the following formula (4).

Ph³-R-Ph⁴-O— (2)

wherein Ph³ and Ph⁴ each independently represents a group represented by the following formula (4), and R represents an alkylidene group having 1 to 5 carbon atoms.

—(Ph⁵)ₙ—O— (3)

wherein Ph⁵ represents a group represented by the following formula (4), n represents an integer of 1 to 3 and, when n is 2 or more, existing a plurality of Ph⁵(s) may be the same or different from each other.

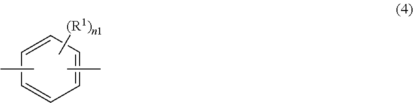

wherein R¹ represents an alkyl group having 1 to 6 carbon atom, an alkenyl group having 3 to 10 carbon atoms, a phenyl group or a halogen atom, n1 represents an integer of 0 to 4 and, when n1 is 2 or more, existing a plurality of R¹(s) may be the same or different from each other.

When the aromatic polysulfone resin contains a repeating unit (1), n1 in the formula (4), which represents Ph¹ and Ph² in the formula (1), is preferably 0 and a group represented by the formula (4) is preferably a p-phenylene group. Also, the content of the repeating unit (1) is preferably 80 mol % or more based on the total amount of the whole repeating unit constituting the aromatic polysulfone resin. Therefore, the aromatic polysulfone resin preferably contains a repeating unit represented by the following formula (1a) in the amount of 80 mol % or more based on the total amount of the whole repeating units contained in the aromatic polysulfone resin.

-pC₆H₄—SO₂-pC₆H₄—O— (1a)

wherein pC₆H₄ represents an p-phenylene group.

When the aromatic polysulfone resin contains repeating units (1) and (2), n1 in the formula (4), which represents Ph¹ and Ph² in the formula (1) as well as Ph³ and Ph⁴ in the formula (2), is preferably 0, a group represented by the formula (4) is preferably a p-phenylene group, and R in the formula (2) is preferably an isopropylidene group. Also, a molar ratio of a repeating unit (1)/[repeating unit (1)+repeating unit (2)] is preferably 0.8 or more.

When the aromatic polysulfone resin contains repeating units (1) and (3), n1 in the formula (4), which represents Ph¹ and Ph² in the formula (1) as well as Ph⁵ in the formula (3), is preferably 0, a group represented by the formula (4) is preferably a p-phenylene group, and n in the formula (3) is preferably 1 or 2. Also, a molar ratio of a repeating unit (1)/[repeating unit (1)+repeating unit (3)] is preferably 0.8 or more.

The aromatic polysulfone resin is preferably an aromatic polysulfone resin substantially consisting only of a repeating unit (1) or an aromatic polysulfone resin substantially consisting only of repeating units (1) and (2), and more preferably an aromatic polysulfone resin substantially consisting only of a repeating unit (1).

Examples of a commercially available product of the aromatic polysulfone resin include “Sumika Excel PES3600P” and “Sumika Excel PES4100P” (aromatic polysulfone resins containing a repeating unit (1)) manufactured by Sumitomo Chemical Company, Limited; and “UDEL P-1700” (an aromatic polysulfone resin containing repeating units (1) and (2)) manufactured by Solvay Advanced Polymers. An end group of the aromatic polysulfone resin can be appropriately selected according to the production method and examples thereof include —Cl, —OH and —OR (R: alkyl group).

Also, the melt viscosity measured at 340° C. and a shearing speed of 1,216/sec of the aromatic polysulfone resin is preferably from 100 to 600 Pa·s, and more preferably from 100 to 400 Pa·s. It is not preferred that the melt viscosity is too high since the melt viscosity of the obtained composition also becomes high and it becomes difficult to process the composition. Also, it is not preferred that the melt viscosity is too low since the heat resistance and mechanical strength of the obtained composition are likely to deteriorate.

A ratio (ηₐ/η_{b}) of a melt viscosity (ηₐ) measured at 340° C. and a shearing speed of 1,216/sec of the aromatic polycarbonate resin to a melt viscosity (η_{b}) of the aromatic polysulfone resin is preferably from 0.5 to 2.0, more preferably from 0.8 to 1.8, and still more preferably from 1.0 to 1.6. It is not preferred that the ratio is too small since the heat resistance of the obtained composition is likely to deteriorate. Also, it is not preferred that the ratio is too large since it becomes difficult for the aromatic polycarbonate resin to disperse and the transparency of the obtained composition is likely to deteriorate.

In the present invention, a thermoplastic resin composition is produced by melt-kneading an aromatic polycarbonate resin and an aromatic polysulfone resin. Regarding the amounts of the aromatic polycarbonate resin and the aromatic polysulfone resin to be used, the amount of the aromatic polycarbonate resin is from 5 to 55 parts by weight and that of the aromatic polysulfone resin is 45 to 95 parts by weight, based on 100 parts by weight of the total amount of both resins. Preferably, the amount of the aromatic polycarbonate resin is from 25 to 45 parts by weight and that of the aromatic polysulfone resin is from 55 to 75 parts by weight. When the amount of the aromatic polycarbonate resin is too large and that of the aromatic polysulfone resin is too small, the heat resistance of the obtained composition becomes insufficient. In contrast, when the amount of the aromatic polycarbonate resin is too small and that of the aromatic polysulfone resin is too large, the processability of the obtained composition becomes insufficient.

In the present invention, as long as the transparency of the obtained composition is not impaired, components other than the aromatic polycarbonate resin and the aromatic polysulfone resin may be optionally used as raw materials, and examples thereof include fiber- or needle-shaped reinforcing agents, such as glass fibers, silica alumina fibers, alumina fibers, carbon fibers and aluminum borate whiskers; inorganic fillers such as talc, mica, clay and glass beads; release modifiers such as fluorine resins and metal soaps; coloring agents such as dyes and pigments; antioxidants; heat stabilizers; ultraviolet absorbers; antistatic agents; and surfactant. If necessary, two or more kinds of these components may be used. Also, a small amount of thermoplastic resins, for example, polyethylene, polypropylene, polyvinyl chloride, an ABS resin, polystyrene, methacrylic resin, polyimide, polyester, polyphenylene sulfide, polyetherketone, polyphenylene ether and polyetherimide; and a small amount of thermosetting resins, for example, a phenol resin, an epoxy resin, a cyanate resin, an isocyanate resin and a polyimide resin; and a small amount of rubber components alone. The thermoplastic resin and the thermosetting resin each may or may not have substituent(s), and also each may be used singly, or two or more of them may be used in combination.

In the present invention, melt-kneading of the aromatic polycarbonate resin and the aromatic polysulfone resin is carried out while shearing at a shearing speed of from 1,000/sec to 9,000/sec. By melt-kneading at a high shearing speed within the range mentioned above in such a manner, a composition having excellent transparency can be obtained. The shearing speed is preferably from 1,000/sec to 5,000/sec, and more preferably from 1,000/sec to to 3,000/sec. When the shearing speed is too small, the transparency of the obtained composition becomes insufficient because of insufficient compatibility. In contrast, when the shearing speed is too large, the transparency of the obtained composition becomes insufficient because of heat deterioration.

The melt-kneading can be carried out using a high shear type kneader which can conduct melt-kneading in a nano-level dispersion and mixing, that could not have been carried out by a conventional twin screw extruder. Examples of the high shear type kneader include a completely intermeshing co-rotating parallel four screw extruder (for example, “KZW FR”, manufactured by TECHNOVEL CORPORATION) or a high-shear processing machine equipped with a return type screw (high shear processing machine “NHSS2-28”, manufactured by NIIGATA MACHINE TECHNO CO., LTD.), and particularly preferably a high-shear processing machine equipped with return type screw.

The melt-kneading may be carried out by mixing an aromatic polycarbonate resin, an aromatic polysulfone resin and, if necessary, another component in advance using a Henschel mixer, a tumbler and the like, and then feeding the obtained mixture to a kneader. Also, when the other components are used, melt-kneading may be carried out by mixing an aromatic polycarbonate resin and an aromatic polysulfone resin in advance, and then separately feeding the obtained mixture and the other components to a kneader. From the viewpoint of handling, melt-kneading may also be carried out by melt-kneading an aromatic polycarbonate resin, an aromatic polysulfone resin and, if necessary, other components under low shearing using a conventional extruder to from pellets, and then melt-kneading the obtained pellets under high shearing speed of from 1,000/sec to 9,000/sec.

The thus obtained thermoplastic resin composition has both impact resistance and melt fluidity of the aromatic polycarbonate resin and chemical resistance of the aromatic polysulfone resin, and also has excellent heat resistance and excellent transparency, and is therefore preferably used as a molding material for the production of various moldings. Various methods capable of melting, shaping and solidifying a resin can be employed as the molding method and examples thereof include extrusion, injection molding and blow molding methods. Among these molding methods, an injection molding method is preferably used. The obtained molding may be further processed by cutting or pressing.

Examples of the molding include components of automobiles and aircrafts, industrial instruments, household electrical appliances, tablewares, medical instruments, food containers, Office Automation (OA) and Audiovisual (AV) machines, electric and electronic components, semiconductor manufacturing process related components, household daily necessaries, and packaging and container materials. In particular, the thermoplastic resin composition obtained by the present invention can be suitably used as materials of products and components that require heat resistance and transparency, for example, lamp components, joints, valves, microwave oven containers, coffee server containers, wafer carriers, sensors components, and components in an engine room.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2010-77185 filed on Mar. 30, 2010, including specification, claims and summary, is incorporated herein by reference in their entirety.

### EXAMPLES

Examples of the present invention will be described below, but the present invention is not limited thereto. The melt viscosity, glass transition temperature (indicator of heat resistance) and Haze (indicator of transparency) were measured by the following respective procedures.

### Melt Viscosity:

A melt viscosity was measured by “CAPIROGRAPH 1B” manufactured by TOYO SEIKI SEISAKU-SHO, LTD. at a temperature of 340° C. and a shearing speed of 1,216/sec, using an orifice measuring 1 mm in inner diameter and 10 mm in length.

### Glass Transition Temperature:

Using “DSC50” manufactured by Shimadzu Corporation, a glass transition temperature was measured in accordance with JIS K7121.

### Haze:

Using “HGM-2D-P” manufactured by Suga Test Instruments Co., Ltd., Haze was measured in accordance with JIS K7105.

### Example 1

After mixing 10 parts by weight of an aromatic polycarbonate resin having a melt viscosity of 350 Pa·s (“CALIBRE 200-3”, manufactured by Sumitomo Dow Limited) with 90 parts by weight of an aromatic polysulfone resin having a melt viscosity of 366 Pa·s (“Sumika Excel PES 3600P”, manufactured by Sumitomo Chemical Company, Limited) by a Henschel mixer, the obtained mixture was granulated by kneading using a twin screw extruder (“PCM-30”, manufactured by Ikegai Iron Works) at a cylinder temperature 340° C. under shearing at 100/sec to obtain an opaque resin composition. The obtained composition was charged in a high shear processing machine equipped with a return type screw (“NHSS2-28”, manufactured by NIIGATA MACHINE TECHNO CO., LTD., screw diameter: 28 mm, inner diameter of screw return section: φ2 mm) and, after setting a gap to 2 mm, the composition was heat-melted at a plasticating section temperature of 300° C. and a kneading section temperature of 230° C. After setting a screw rotation speed to 1,000 rpm, the melted composition was kneaded under shearing at 1,470/sec for 30 seconds and then extruded through a T-die to obtain a transparent resin composition. In that case, in order to reduce shear heat generation, the temperature was controlled using a cooling mechanism so that the temperature of the kneading section does not exceed 230° C. The glass transition temperature of the obtained resin composition was measured. The results are shown in Table 1. Using a press (“NP-37”, manufactured by SHINTO Metal Industries Corporation, the obtained resin composition was formed into a molding measuring 50 mm×50 mm×1 mmt at 280° C. and Haze of the obtained molding was measured. The results are shown in Table 1.

### Example 2

The same operation as in Example 1 was carried out, except that the screw rotation speed was set to 3,000 rpm and kneading was carried out under shearing at 4,400/sec. The results are shown in Table 1.

### Example 3

The same operation as in Example 2 was carried out, except that a return type screw was changed from the one having an inner diameter of φ2 mm in the screw return section to the one having an inner diameter of φ4 mm in the screw return section. The results are shown in Table 1.

### Comparative Example 1

In the same manner as in Example 1, after mixing 10 parts by weight of an aromatic polycarbonate resin having a melt viscosity of 350 Pa·s (“CALIBRE 200-3”, manufactured by Sumitomo Dow Limited) with 90 parts by weight of an aromatic polysulfone resin having a melt viscosity of 366 Pa·s (“Sumika Excel PES 3600P”, manufactured by Sumitomo Chemical Company, Limited) by a Henschel mixer, the obtained mixture was granulated by kneading using a twin screw extruder (“PCM-30”, manufactured by Ikegai Iron Works) at a cylinder temperature 340° C. under shearing at 100/sec to obtain an opaque resin composition. The glass transition temperature of the obtained resin composition was measured. The results are shown in Table 1. Using an injection molding machine (“PS40 E5ASE”, manufactured by Nissei plastic Industrial Co., Ltd.), the resin composition was formed into a molding measuring 50 mm×50 mm×1 mmt at a cylinder temperature of 350° C. and a mold temperature of 120° C., and Haze of the obtained molding was measured. The results are shown in Table 1.

TABLE 1

| | | Glass | |
|---|---|---|---|
| | | transition | |
| | Shear | temperature | Haze |
| Examples | (/sec) | (° C.) | (%) |
| Example 1 | 1470 | 206 | 6.1 |
| Example 2 | 4400 | 206 | 8.4 |
| Example 3 | 4400 | 206 | 10.5 |
| Comparative | 100 | 150, 221 | 86.5 |
| Example 1 | | | |

What is claimed is:

1. A method for producing a thermoplastic resin composition, the method comprising a step of melt-kneading 5 to 55 parts by weight of an aromatic polycarbonate resin and 95 to 45 parts by weight of an aromatic polysulfone resin while shearing at a shearing speed of from 1,000 to 9,000/sec.

2. The method according to claim 1, wherein melt-kneading of the aromatic polycarbonate resin and the aromatic polysulfone resin is carried out by a kneader equipped with a return type screw.

3. The method according to claim 1, wherein the aromatic polycarbonate resin has a group derived from bisphenol A in the amount of 30 mol % or more based on the total amount of a group derived from a dihydric phenol contained in the aromatic polycarbonate resin.

4. The method according to claim 1, wherein the aromatic polysulfone resin contains a repeating unit represented by the formula (1a) shown below in the amount of 80 mol % or more based on the total amount of the whole repeating units contained in the aromatic polysulfone resin:
-pC₆H₄—SO₂-pC₆H₄—O— (1a)
wherein pC₆H₄ represents a p-phenylene group.
